(19) United States
(12) Patent Application Publication
(10) Pub. No.: US 2022/0066849 A1
(43) Pub. Date: Mar. 3, 2022

(54) DATA COORDINATION SYSTEM AND API PLATFORM

(71) Applicant: KYOCERA Document Solutions Inc., Osaka-shi (JP)

(72) Inventor: Koki NAKAJIMA, Osaka-shi (JP)

(21) Appl. No.: 17/408,580

(22) Filed: Aug. 23, 2021

(30) Foreign Application Priority Data
Aug. 26, 2020 (JP) 2020-142897

(51) Int. Cl. G06F 9/54; G06F 16/22; H04L 29/06

(52) U.S. Cl. CPC G06F 9/547; H04L 63/0884; G06F 16/2282; G06F 9/541

(57) ABSTRACT

An API platform of a data coordination system characterized in that it notifies a user of an analysis result when a data size of the analysis result by a big data analyzer does not exceed an available data analysis usage that is managed by an authorization service for the user authenticated by an authentication service, and characterized in that it does not notify the user of the analysis result and can accept an instruction to change an analysis content of the big data analyzer when the data size of the analysis result by the big data analyzer exceeds the available data analysis usage that is managed by the authorization service for the user authenticated by the authentication service.

### INCORPORATION BY REFERENCE

This application is based upon, and claims the benefit of priority from, corresponding Japanese Patent Application No. 2020-142897 filed in the Japan Patent Office on Aug. 26, 2020, the entire contents of which are incorporated herein by reference.

### BACKGROUND

### Field of the Invention

The present disclosure relates to a data coordination system which collects and accumulates data held by an information system, and to an API platform.

### Description of Related Art

Typically, a system, which provides an API (Application Program Interface) to acquire execution results of a specific algorithm corresponding to a data coordinate process between a plural of SaaS (Software as a Service), is known.

### SUMMARY

A data coordination system of the present disclosure includes: a data collection system to collect data held by an information system; a big data analyzer to analyze the data collected by the data collection system; an API platform to provide an API (Application Program Interface) to execute a specific operation by using the data managed by the big data analyzer; an authentication service to authenticate a user; and an authorization service to manage for each user an available data analysis usage usable by the big data analyzer, wherein when a data size of an analysis result by the big data analyzer does not exceed the available data analysis usage that is managed by the authorization service for the user authenticated by the authentication service, the API platform notifies the user of the analysis result, and when the data size exceeds the available data analysis usage that is managed by the authorization service for the user authenticated by the authentication service, the API platform does not notify the user of the analysis result and can accept at least one of an instruction to change an analysis content of the big data analyzer and an instruction to increase the available data analysis usage.

An API platform of the present disclosure is the API platform to provide an API (Application Program Interface) to execute a specific operation by using data managed by a big data analyzer that analyzes data collected by a data collection system that collects data held by an information system, wherein when a data size of an analysis result by the big data analyzer does not exceed an available data analysis usage that is managed by an authorization service that manages for each user the available data analysis usage usable by the big data analyzer for the user authenticated by an authentication service, the API platform notifies the user of the analysis result, and when the data size exceeds the available data analysis usage that is managed by the authorization service for the user authenticated by the authentication service, the API platform does not notify the user of the analysis result and can accept at least one of an instruction to change an analysis content of the big data analyzer and an instruction to increase the available data analysis usage.

### BRIEF DESCRIPTION OF THE DRAWINGS

FIG. 1 is a block diagram illustrating a system according to an embodiment of the present disclosure;

FIG. 2 is a block diagram illustrating an API platform shown in FIG. 1;

FIG. 3 is a diagram illustrating an example of combination patterns of predicted processing time levels and predicted response data amount levels acquired with an API controller shown in FIG. 2;

FIG. 4 is a diagram illustrating an example of a correspondence between queue IDs which means identification information of the queue shown in FIG. 2 and the combination patterns of the predicted processing time levels and the predicted response data amount levels;

FIG. 5 is a block diagram illustrating an authentication and authorization service shown in FIG. 1;

FIG. 6 is a sequence diagram illustrating an operation of a data coordination system shown in FIG. 1 when specifying a queue to store a process request message;

FIG. 7 is a sequence diagram illustrating an operation of the data coordination system shown in FIG. 1 when a user logs in;

FIG. 8 is a sequence diagram illustrating an operation of the data coordination system shown in FIG. 1 when a data analysis is requested;

FIG. 9 is a sequence diagram illustrating the data analysis shown in FIG. 8;

FIG. 10 is a diagram illustrating an example of a screen displayed on a display unit of a user terminal in the operation shown in FIG. 9;

FIG. 11 is a diagram illustrating an example different from the example shown in FIG. 10 of the screen displayed on the display unit of the user terminal in the operation shown in FIG. 9; and

FIG. 12 is a sequence diagram illustrating the operation of the data coordination system shown in FIG. 1 when increasing a permitted data analysis usage.

### DETAILED DESCRIPTION

Now, some embodiments of the present disclosure will be described below with reference to the drawings.

First, a configuration of a system according to an embodiment of the present disclosure is described.

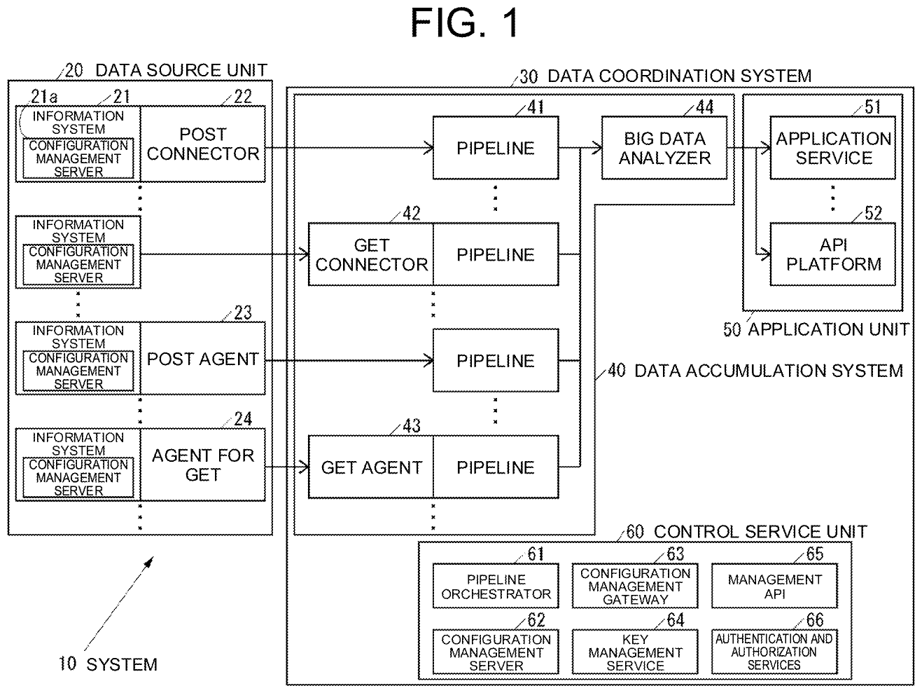

FIG. 1 is a block diagram illustrating a system 10 according to the present embodiment.

As shown in FIG. 1, the system 10 includes a data source unit 20 to generate data and a data coordination system 30 to share the data generated by the data source unit 20.

The data source unit 20 includes an information system 21 to generate data. The information system 21 includes a configuration management server 21a to store a configuration and setting of the information system 21. The data source unit 20 may include at least one information system other than the information system 21. As examples of the information system, there are an IoT (Internet of Things) system, which is for example a remote management system to remotely manage an image forming apparatus such as MFP (Multifunction Peripheral) or a dedicated printer, and an intra-company system such as an ERP (Enterprise Resource Planning) or a production management system. Each information system may be configured by one or more computers. Each information system may be constructed on a public cloud. The information system may hold a file of structured data. The information system may hold a file of unstructured data. The information system may hold a database of the structured data.

The data source unit 20 includes a POST connector 22 as a data collection system which acquires the file of the structured data or unstructured data held by the information system and transmits the acquired file to a pipeline of the data coordination system 30, as described later. The data source unit 20 may include at least one POST connector with a configuration similar to a configuration of the POST connector 22 other than the POST connector 22. The POST connector may be configured by a computer to constitute the information system in which the POST connector acquires the file by itself. The data coordination system 30 also includes the POST connector.

The data source unit 20 includes a POST agent 23 as the data collection system which acquires structured data from a database of the structured data held by the information system and transmits the acquired structured data to a pipeline of the data coordination system 30, as described later. The data source unit 20 may include at least one POST agent with a configuration similar to a configuration of the POST agent 23 other than the POST agent 23. The POST agent may be configured by a computer to constitute the information system in which the POST agent acquires the structured data by itself. The data coordination system 30 also includes the POST agent.

The data source unit 20 includes an agent for GET 24 as the data collection system which generates the structured data to coordinate based on the data held by the information system. The data source unit 20 may include at least one agent for GET with a configuration similar to a configuration of the agent for GET 24 other than the agent for GET 24. The agent for GET agent may be configured by a computer to constitute the information system which holds original data of generation of the structured data to coordinate. The data coordination system 30 also includes the agent for GET.

The data coordination system 30 includes a data accumulation system 40 to accumulate data generated by the data source unit 20, an application unit 50 to use the data accumulated in the data accumulation system 40, and a control service unit 60 to execute various controls on the data accumulation system 40 and the application unit 50. Each component of the data coordination system 30 may be constructed on a public cloud.

The data accumulation system 40 includes a pipeline 41 to accumulate the data generated by the data source unit 20. The data accumulation system 40 may include at least one pipeline other than the pipeline 41. Since the data configurations in the information systems are possibly different from each other, the data accumulation system 40 basically includes a separate pipeline for every information system. Each pipeline may be configured by one or more computers.

The data accumulation system 40 includes a GET connector 42 as the data collection system which acquires the file of the structured data or unstructured data held by the information system and shares the acquired file with the pipeline. The data accumulation system 40 may include at least one GET connector with a configuration similar to a configuration of the GET connector 42 other than the GET connector 42. The GET connector may be configured by a computer in which the GET connector constitutes the pipeline to share the file by itself.

The system 10 includes a POST connector in the data source unit 20 for the information system which works so as not to allow the data accumulation system 40 to acquire the structured data file or unstructured data file from it. On the other hand, the system 10 includes the GET connector in the data accumulation system 40 for an information system which works so as to allow the data accumulation system 40 to acquire the structured data file or unstructured data file from it.

The data accumulation system 40 includes a GET agent 43 as the data collection system which acquires the structured data generated by the agent for GET and shares the acquired structured data with the pipeline. The data accumulation system 40 may include at least one GET agent with a configuration similar to a configuration of the GET agent 43 other than the GET agent 43. The GET connector may be configured by a computer in which the GET agent constitutes the pipeline to share the constructed data by itself.

The system 10 includes a POST agent in the data source unit 20 for the information system which works so as not to allow the data accumulation system 40 to acquire the structured data from it. On the other hand, the system 10 includes the GET agent in the data accumulation system 40 as well as the agent for GET in the data source unit 20 for an information system which works so as to allow the data accumulation system 40 to acquire the structured data from it.

The data accumulation system 40 includes a big data analyzer 44 as a data conversion system to execute a final conversion process in data conversion processes for converting a data form accumulated by a plurality of pipelines into a data form which can be searched or aggregated by a query language such as a database language, for example SQL. The big data analyzer 44 can also execute on the data, on which the final conversion process has been executed, a search or aggregation process in response to a search request or an aggregation request from the application unit 50. The big data analyzer 44 may be configured by one or more computers.

The final conversion process may include as a data conversion process a data integration process for integrating data of a plurality of information systems. In a case where the system 10 includes as information systems an Asia-located remote management system to remotely manage a large number of image forming apparatuses located in Asia, an Europe-located remote management system to remotely manage a large number of image forming apparatuses located in Europe, and the United States-located remote management system to remotely manage a large number of image forming apparatuses located in the United States, each of the three remote management systems independently includes a device management table to manage the image forming apparatuses to be managed by itself. The device management table indicates various types of information of the image forming apparatuses by correlating it with an ID assigned to each image forming apparatus. Here, since each of the three remote management systems independently include the device management table, the same ID may be possibly assigned to separate image forming apparatuses among the device management tables through the three remote management systems. Therefore, when one device management table is generated by integrating the device management tables of the three remote management systems, the big data analyzer 44 reassigns the IDs of the image forming apparatuses so that no IDs overlaps.

An application unit 50 includes an application service 51 to execute a specific operation, which is instructed by a user, to display the data or analyze the data, for example, by using the data managed by the big data analyzer 44. The application unit 50 may include at least one application service other than the application service 51. Each application service may be configured by one or more computers. The application service is, for example, BI (Business Intelligence) tool, SaaS (Software as a Service) server, etc.

The application unit 50 includes an API platform 52 to provide an API (Application Program Interface) that executes a specific operation by using the data managed by the big data analyzer 44. The API platform 52 may be configured by one or more computers. The API provided by the API platform 52 may be not only called from an external system outside of the system 10 such as the BI tool, the SaaS server, or the like, but also called from the application service of the application unit 50. The API provided by the API platform 52 acquires from the data accumulation system 40 data on the basis of the data accumulated by the data accumulation system 40. For example, as the APIs provided by the API platform 52, there are: the API to transmit data on a remaining amount of consumables collected from the image forming apparatuses by the remote management system to an external consumables order system outside of the system 10, which orders the consumables when the remaining amount of the consumables such as a toner for the image forming apparatus is not more than a particular amount; the API to transmit various types of data collected from the image forming apparatuses by the remote management system to an external failure prediction system outside of the system 10, which predicts the failure of the image forming apparatus; the API to transmit counter information representing the number of printed sheets collected from the image forming apparatuses by the remote management system to an external system outside of the system 10; the API to transmit data indicating a usage status of the system 10 by the user of the system 10 to an external system outside of the system 10; and the API to accept a search query for acquiring optional data on the basis of the data managed by the system 10.

A control service unit 60 includes as a processing monitoring system a pipeline orchestrator 61 which monitors the process for the data at each of steps in the data source unit 20, the data accumulation system 40, and the application unit 50. The pipeline orchestrator 61 may be configured by one or more computers.

The control service unit 60 includes a configuration management server 62 which stores the configuration and settings of the data accumulation system 40 and automatically executes deployment as necessary. The configuration management server 62 may be configured by one or more computers.

The control service unit 60 includes a configuration management gateway 63, which is connected to the configuration management server of the information system, to collect information for detecting a change in the configuration associated with the database or the unstructured data in the information system, that is, a change in the configuration of the data in the information system. The configuration management gateway 63 may be configured by one or more computers.

The control service unit 60 includes a key management service 64 to encrypt and store security information such as key information or a connection character string necessary for making a coordination among systems such as the information systems. The key management service 64 may be configured by one or more computers.

The control service unit 60 includes a management API 65 to accept the request from the data accumulation system 40 or the application unit 50. The management API 65 may be configured by one or more computers.

The control service unit 60 includes an authentication and authorization service 66 to execute an authentication and authorization process of the application service of the application unit 50. The authentication and authorization service 66 may be configured by one or more computers. The authentication and authorization service 66 can for example confirm whether the application service is authorized to request to update to the latest the data of the information system accumulated in the data accumulation system 40.

Hereinafter, a system outside of the API platform 52 is simply referred to as an external system. The external system includes systems outside of the system 10 or application services of the application unit 50.

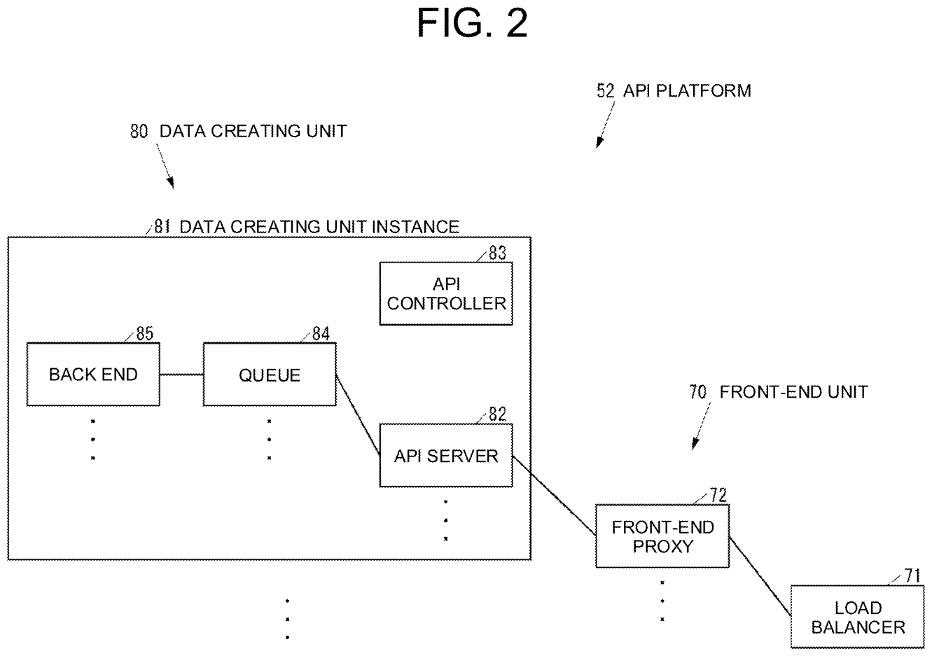

FIG. 2 is a block diagram illustrating the API platform 52.

As shown in FIG. 2, the API platform 52 includes a front-end unit 70 to accept an API use request from the external system, and a data creation unit 80 to create response data in response to the request accepted by the front-end unit 70.

The front-end unit 70 includes an LB (Load Balancer) 71, which is an endpoint revealed to the external system, and a front-end Proxy 72, which establishes a connection with the external system. The front-end unit 70 may include at least one front-end Proxy with a configuration similar to a configuration of the front-end Proxy 72 other than the front-end Proxy 72.

LB 71 notifies any of the front-end Proxies of the API use request from the external system in a round-robin manner.

The front-end Proxy 72 notifies in a round-robin manner any of the API servers described below of the API use request, which is notified from the LB 71. The front-end Proxy 72 maintains the connection with the external system until the data creation unit 80 finishes processing the request accepted by the front-end unit 70, and upon the data creation unit 80 finishes processing the request accepted by the front-end unit 70, the response data created by the data creation unit 80 is notified via the LB 71 to the external system.

The data creation unit 80 includes a data creation unit instance 81. The data creation unit 80 may include at least one data creation unit instance with a configuration similar to a configuration of the data creation unit instance 81 other than the data creation unit instance 81.

The data creation unit instance 81 includes an API server 82 to provide an API that executes a specific operation by using the data managed by the big data analyzer 44 (see FIG. 1). The API server 82 causes a queue described below to hold a request for the process to acquire data from the data accumulation system 40 in response to the API use request. The data creation unit instance 81 may include at least one API server with a configuration similar to a configuration of the API server 82 other than the API server 82.

The data creation unit instance 81 includes an API controller 83 that acquires from the control service unit 60 (see FIG. 1) a predicted processing time level which indicates a time period predicted to be necessary (hereinafter, referred to as a predicted processing time) for the process to acquire the data in response to the API use request from the external system, and a predicted response data amount level which indicates the amount of data predicted to respond (hereinafter, referred to as a predicted response data amount) to the API use request from the external system.

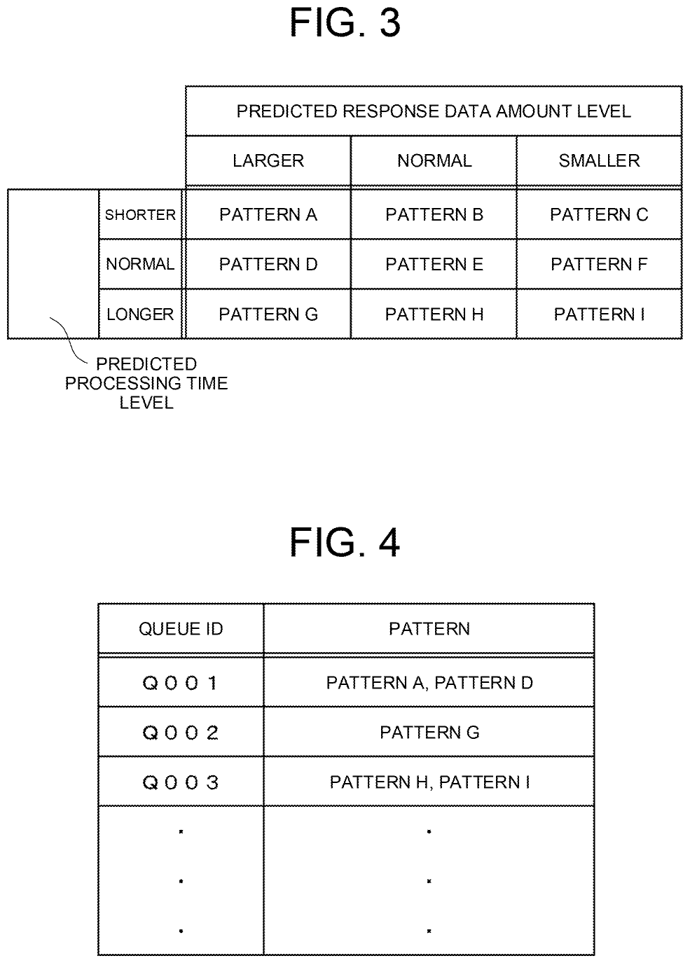

FIG. 3 is a diagram illustrating an example of combination patterns of the predicted processing time levels and predicted response data amount levels acquired with the API controller 83.

In the example illustrated in FIG. 3, the predicted processing time levels include “NORMAL” indicating that the predicted processing time falls within a specific range, “LONGER” indicating that the predicted processing time is longer than an upper limit of the specific range, and “SHORTER” indicating that the predicted processing time is shorter than a lower limit of the specific range. The predicted response data amount levels include “NORMAL” indicating that the predicted response data amount falls within a specific range, “LARGER” indicating that the predicted response data amount is larger than an upper limit of the specific range, and “SMALLER” indicating that the predicted response data amount is smaller than a lower limit of the specific range. In the example shown in FIG. 4, there are nine patterns, which are Pattern A, Pattern B, . . . , and Pattern I, of combinations of the predicted processing time levels and the predicted response data amount levels.

As shown in FIG. 2, the data creation unit instance 81 includes a queue 84 to store a process request message indicating a process request according to the API requested for use from the external system. The data creation unit instance 81 may include at least one queue with a configuration similar to a configuration of the queue 84 other than the queue 84. The queue is provided for every classification on the basis of a pattern of combinations of the predicted processing time levels and the predicted response data amount levels.

FIG. 4 is a diagram illustrating an example of a correspondence between queue IDs which means identification information of the queue and the combination patterns of the predicted processing time levels and the predicted response data amount levels.

As shown in FIG. 4, in the classification on the basis of the combination patterns of the predicted processing time levels and the predicted response data amount levels, pattern A may fall within the same classification as pattern D, and pattern H may fall within the same classification as pattern I, for example. In FIG. 4, information on a part of the queue is omitted.

As shown in FIG. 2, the data creation unit instance 81 includes a backend 85 which is a server to transmit the process request indicated by the process request message stored in the queue 84 to the big data analyzer 44 (see FIG. 1). The backend 85 executes a process for acquiring data from the data accumulation system 40 in response to the process request message held by the queue 84. The data creation unit instance 81 may include at least one backend with a configuration similar to a configuration of the backend 85 other than the backend 85. The backend is provided for every queue. Multiple backends may be provided for a single queue. The process request messages stored in the queue are extracted in order from the queue by the backend ready to process the process request messages among the backends associated with the queue.

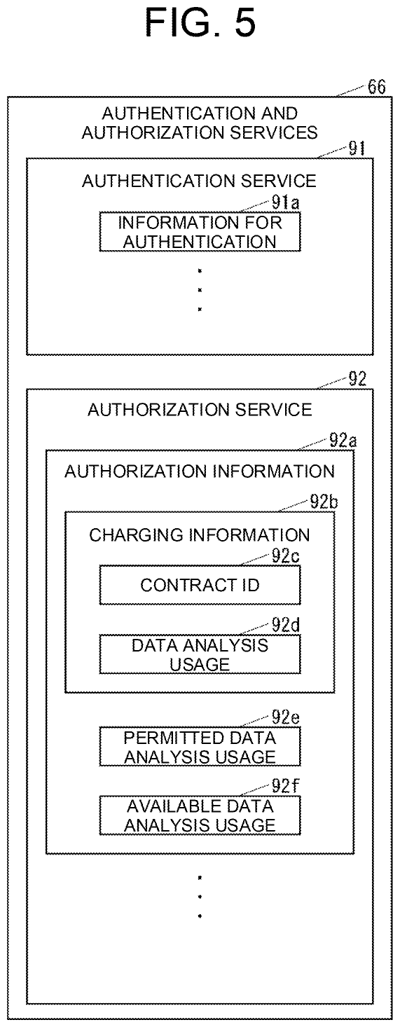

FIG. 5 is a block diagram illustrating the authentication and authorization service 66.

As shown in FIG. 5, the authentication and authorization service 66 includes an authentication service 91 to execute a user authentication and an authorization service 92 to execute a user authorization. The authentication service 91 manages information for authentication 91a for each user, which is used to execute the user authentication. The authorization service 92 manages authorization information 92a for each user. The authorization information 92a includes charging information 92b. The charging information 92b includes a contract ID 92c for identifying a contract of the user in association with a data analysis by the big data analyzer 44, and a data analysis usage 92d indicating an amount of the data analysis the user is currently using through the big data analyzer 44. The authorization information 92a includes a permitted data analysis usage 92e indicating the amount of the data analysis the user is permitted to use through the big data analyzer 44, and an available data analysis usage 92f, which is a usable amount of the data analysis by the big data analyzer 44, that is, a value obtained by subtracting the data analysis usage 92d from the permitted data analysis usage 92e.

The authorization service 92 updates the data analysis usage 92d and the available data analysis usage 92f at a constant interval, such as every month, for example. For example, when the authorization service 92 updates the data analysis usage 92d and the available data analysis usage 92f every month, the authorization service 92 records an end-of-month value of the data analysis usage 92d for a purpose of charging, updates the value of the data analysis usage 92d to zero at the beginning of every month, and updates the value of the available data analysis usage 92f to the same value as the value of the permitted data analysis usage 92e at the beginning of every month.

Next, an operation of the data coordination system 30 when specifying a queue to store the process request message is described.

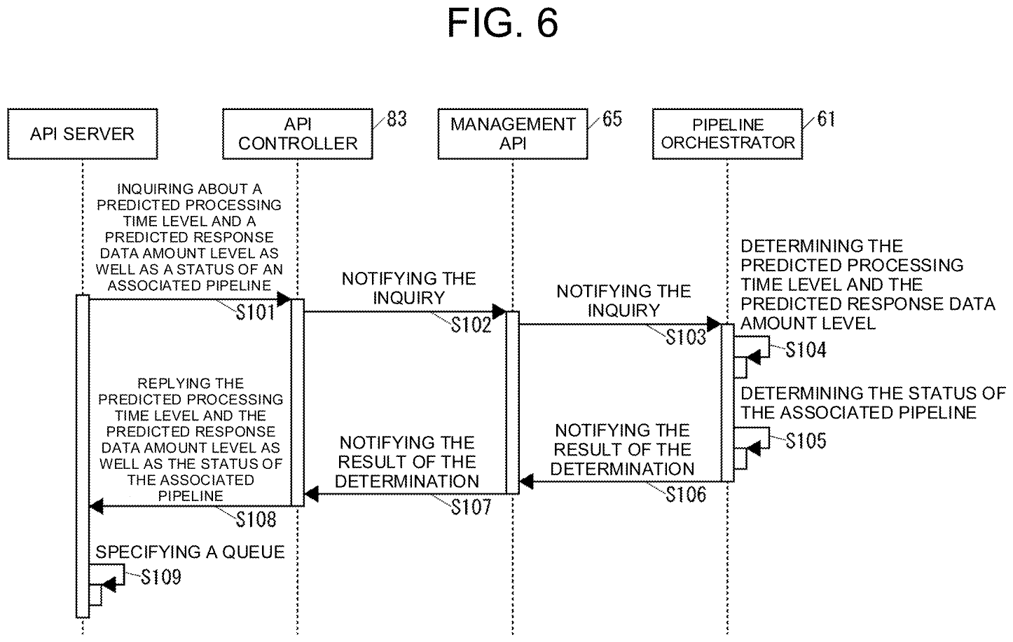

FIG. 6 is a sequence diagram illustrating an operation of the data coordination system 30 when specifying the queue to store the process request message.

As shown in FIG. 6, upon the API server interprets the API use request notified by the front-end Proxy, it inquiries the API controller 83 about the predicted processing time level and the predicted response data amount level of the interpreted request, as well as a status of the pipeline associated with the request (S101).

Upon the API controller 83 receives the inquiry at the step S101, the API controller 83 notifies the management API 65 in the control service unit 60 of the inquiry at the step S101 (S102).

Upon the management API 65 receives the notification at the step S102, the management API 65 notifies the pipeline orchestrator 61 of the inquiry notified at the step S102 (S103).

Upon the pipeline orchestrator 61 receives the notification at the step S103, the pipeline orchestrator 61 determines the predicted processing time level and the predicted response data amount level for a request content of a destination of the inquiry notified at the step S103 (S104).

Next, the pipeline orchestrator 61 determines a status of the pipeline associated with the request of the destination of the inquiry notified at the step S103 (S105). Here, when the pipeline is currently under maintenance, the pipeline orchestrator 61 is notified by the pipeline that the pipeline is under maintenance. Therefore, when the pipeline is currently under maintenance, the pipeline orchestrator 61 can determine that the status of the pipeline is under maintenance.

After the process at the step S105, the pipeline orchestrator 61 notifies the management API 65 of the results of the determinations at the steps S104 and S105, that is, the predicted processing time level and the predicted response data amount level determined at the step S104 as well as the status of the pipeline determined at the step S105 (S106).

Next, the management API 65 notifies the API controller 83 of the results of the determinations notified by the pipeline orchestrator 61 at the step S106 (S107).

Next, the API controller 83 replies to the API server the results of the determinations notified by the management API 65 at the step S107, that is, the predicted processing time level and the predicted response data amount level as well as the status of the pipeline (S108).

Upon the API server receives the reply at the step S108, the API server specifies a queue associated with the combination patterns of the predicted processing time levels and the predicted response data amount levels, which are replied at the step S108 (S109).

Next, the operation of the data coordination system 30 when the user logs in is described.

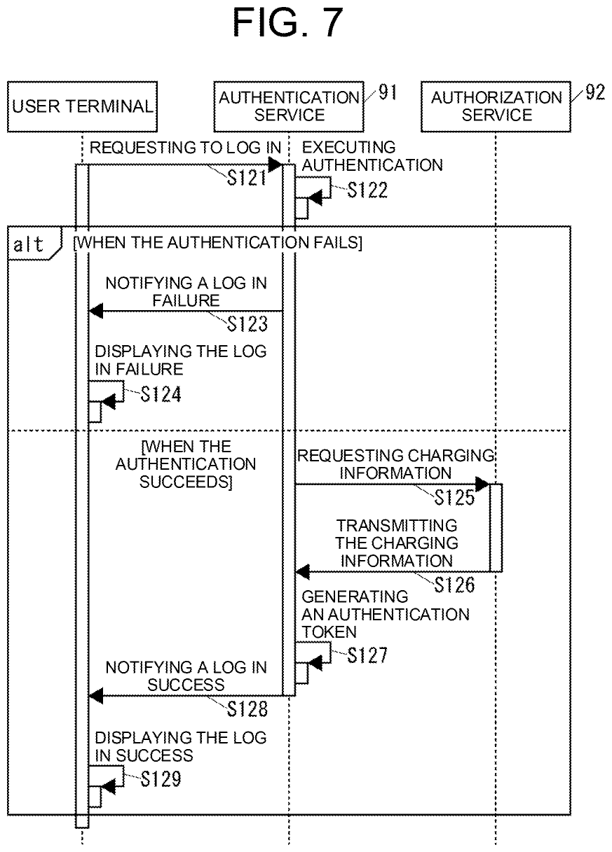

FIG. 7 is a sequence diagram illustrating an operation of the data coordination system 30 when the user logs in.

After the user accesses a URL (Uniform Resource Locator) for logging in to the data coordination system 30 through a user terminal such as a PC (Personal Computer) for example, the user can input user's own instructions to login to the data coordination system 30 into the operation unit of the user terminal. The instructions include authentication information for user's own authentication, which is a combination of the user's own ID and password, for example. Upon the instructions to log in to the data coordination system 30 is input into the user terminal by the user, as shown in FIG. 7, the user terminal requests the authentication service 91 of the authentication and authorization service 66 to log in by the user (S121). The user terminal includes the authentication information for the user in the request at the step S121.

Upon the authentication service 91 receives the request at the step S121, the authentication service executes authentication of the user by using the authentication information included in the request at the step S121 and the information for authentication managed by the authentication service 91 (S122).

When the authentication at the step S122 fails, the authentication service 91 notifies the user terminal of a login failure (S123).

Upon the user terminal receives the notification at the step S123, the user terminal displays the login failure on a display unit of the user terminal (S124).

When the authentication at the step S122 succeeds, the authentication service 91 requests from the authorization service 92 the charging information contained in the authorization information of the user authenticated at the step S122 (S125).

Upon the authorization service 92 receives the request at the step S125, the authorization service 92 transmits to the authentication service 91 the charging information on a destination of the request (S126).

Upon the authentication service 91 receives the charging information transmitted from the authorization service 92 at the step S126, the authentication service 91 generates an authentication token including a received charging information (S127).

After the process at the step S127, the authentication service 91 notifies the user terminal of a login success (S128). The authentication service 91 includes the authentication token generated at the step S127 in the notification at the step S128.

Upon the user terminal is notified of the login success by the authentication service 91 at the step S128, the user terminal displays the login success on the display unit of the user terminal (S129).

Next, the operation of the data coordination system 30 when a data analysis is requested is described.

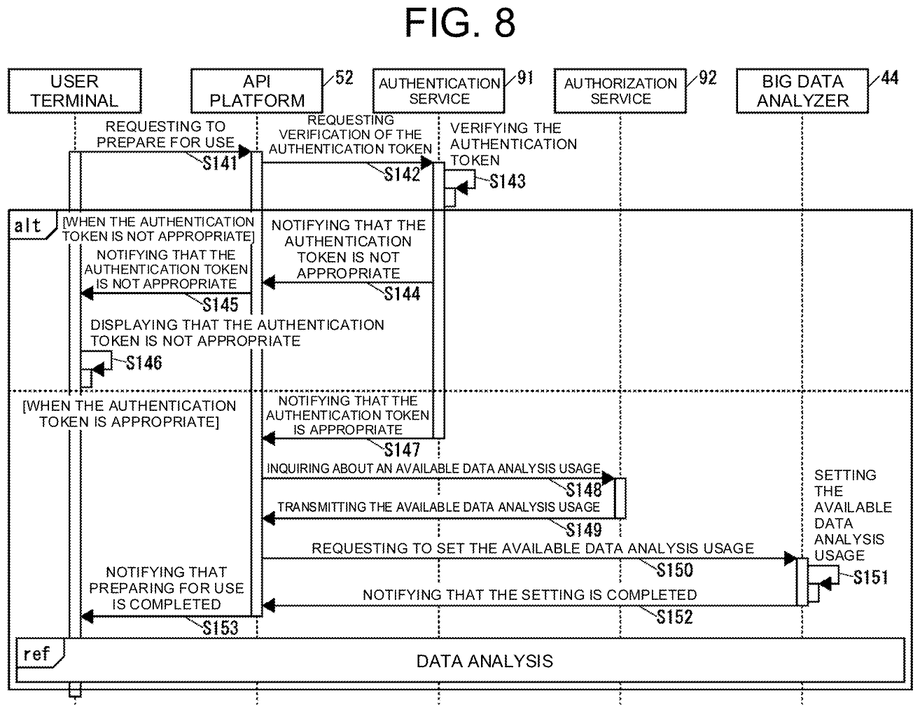

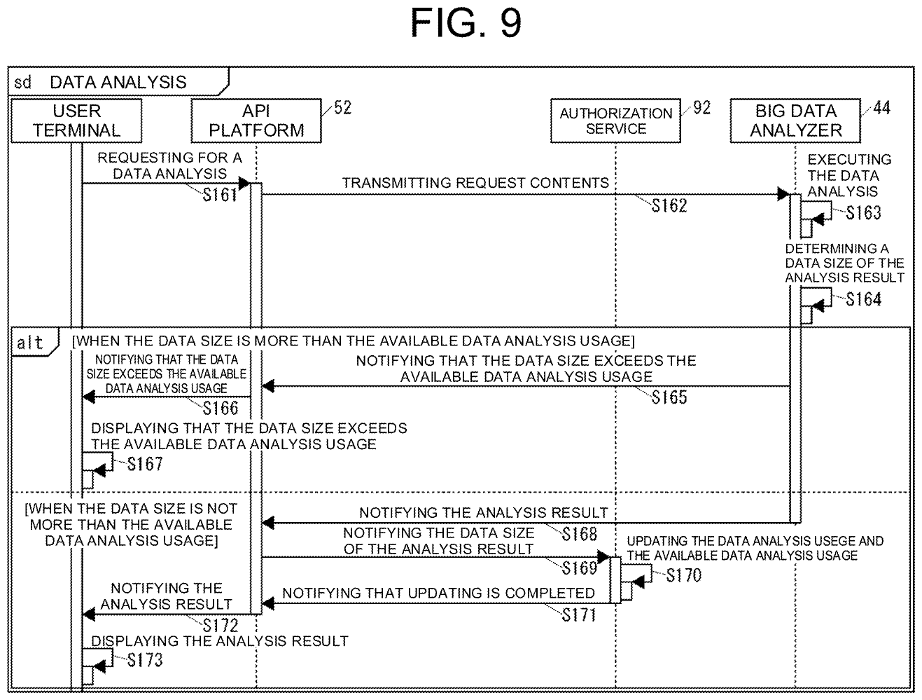

FIG. 8 is a sequence diagram illustrating an operation of the data coordination system 30 when the data analysis is requested. FIG. 9 is a sequence diagram illustrating the data analysis shown in FIG. 8.

After the user accesses a URL of the API platform 52 through the user terminal, the user can input a request for the data analysis into the operation unit of the user terminal. Upon the request for the data analysis is input through the user terminal, as shown in FIGS. 8 and 9, the user terminal requests the API platform 52 to prepare for use of the API platform 52 (S141). The user terminal includes in the request at the step S141 the authentication token notified by the authentication service 91 at the step S128. As analysis contents requested by the user, there are various kinds of analysis contents. For example, as the analysis contents requested by the user, there are aggregation of values in a column which is designated by the user in the table of the data managed by the big data analyzer 44, and acquisition of data, which meet conditions designated by the user, among the data managed by the big data analyzer 44.

Upon the API platform 52 receives the request at the step S141, the API platform 52 requests the authentication service 91 to verify the authentication token included in the request at the step S141 (S142).

Upon the authentication service 91 receives the request at the step S142, the authentication service 91 verifies the authentication token of a destination of the request at the step S142 (S143).

When the authentication service 91 determines at the step S143 that the authentication token of a destination of verification at the step S143 is not appropriate, the authentication service 91 notifies the API platform 52 that the authentication token is not appropriate (S144).

Upon the API platform 52 receives the notification at the step S144, the API platform 52 notifies the user terminal that the authentication token is not appropriate (S145).

Upon the user terminal receives the notification at the step S145, the user terminal displays on the display unit of the user terminal that the authentication token is not appropriate (S146).

When the authentication service 91 determines at the step S143 that the authentication token of the destination of the verification at the step S143 is appropriate, the authentication service 91 notifies the API platform 52 that the authentication token is appropriate (S147).

Upon the API platform 52 receives the notification at the step S147, the API platform 52 inquiries the authorization service 92 about the available data analysis usage corresponding to the contract ID included in the charging information contained in the authentication token included in the request at the step S141 (S148). The API platform 52 includes in the inquiry at the step S148 the contract ID included in the charging information contained in the authentication token included in the request at the step S141.

Upon the authorization service 92 receives the inquiry at the step S148, the authorization service 92 transmits to the API platform 52 the available data analysis usage of a destination of the inquiry at the step S148 (S149).

Upon the API platform 52 receives the available data analysis usage transmitted from the authorization service 92 at the step S149, the API platform 52 requests the big data analyzer 44 to set a received available data analysis usage (S150).

Upon the big data analyzer 44 receives the request at the step S150, the big data analyzer 44 sets the available data analysis usage requested at the step S150 (S151) and notifies the API platform 52 that setting is completed (S152).

Upon the API platform 52 receives the notification at the step S152, the API platform 52 notifies the user terminal that preparing for use of the API platform 52 is completed (S153).

Upon the user terminal receives the notification at the step S153, the user terminal requests the API platform 52 to analyze the data in accordance with the analysis contents requested by the user as described above (S161).

Upon the API platform 52 receives the request at the step S161, the API platform 52 transmits a requested contents at the step S161 to the big data analyzer 44 (S162).

Upon the big data analyzer 44 receives the requested contents transmitted from the API platform 52 at the step S162, the big data analyzer 44 executes the data analysis in accordance with a received requested contents (S163).

After the process at the step S163, the big data analyzer 44 determines a data size of an analysis result at the step S163 (S164).

As a result of the determination at the step S164, if the data size of the analysis result at the step S163 is more than the available data analysis usage set at the step S151, the big data analyzer 44 notifies the API platform 52 that the data size of the analysis result exceeds the available data analysis usage (S165).

Upon the API platform 52 receives the notification at the step S165, the API platform 52 notifies the user terminal that the data size of the analysis result exceeds the available data analysis usage (S166).

Upon the user terminal receives the notification at the step S166, the user terminal displays on the display unit of the user terminal that the data size of the analysis result exceeds the available data analysis usage (S167).

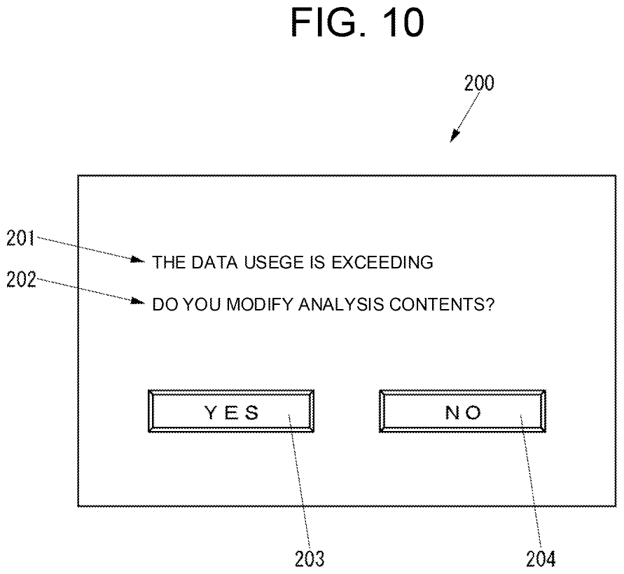

FIG. 10 is a diagram illustrating an example of a screen 200 displayed on the display unit of the user terminal at the step S167.

As shown in FIG. 10, the screen 200 includes a message 201 indicating that the data size of the analysis result exceeds the available data analysis usage, a message 202 for inquiring the user about whether the user desires to modify the analysis contents of the data to a new analysis contents, a YES button 203 for accepting an instruction to modify the analysis contents of the data to a new analysis contents, and a NO button 204 for accepting an instruction not to modify the analysis contents of the data to the new analysis contents. The screen 200 displays the data which is notified to the user terminal by the API platform 52 at the step S166.

When the user desires to modify the analysis contents of the data to a new analysis contents, for example, analysis contents such that the data size of the analysis result is not more than the available data analysis usage, the user can press the YES button 203 and input new analysis contents into the user terminal. Upon the YES button 203 is pressed, the user terminal accepts the input of the new analysis contents, and re-executes the process at the step S161 in accordance with input new analysis contents. Namely, the user terminal requests the API platform 52 to analyze the data in accordance with the input new analysis contents.

As shown in FIGS. 8 and 9, as a result of the determination at the step S164, if the data size of the analysis result at the step S163 is not more than the available data analysis usage set at the step S151, the big data analyzer 44 notifies the analysis result at the step S163 to the API platform 52 (S168).

Upon the API platform 52 receives the notification at the step S168, the API platform 52 notifies the authorization service 92 of the data size of the analysis result notified by the big data analyzer 44 at the step S168 (S169). The API platform 52 includes in the notification at the step S169 the contract ID included in the charging information contained in the authentication token included in the request at the step S141.

Upon the authorization service 92 receives the notification at the step S169, the authorization service 92 updates the data analysis usage and the available data analysis usage, which correspond to the contract ID included in the notification at the step S169, by using the data size notified at the step S169 (S170). Here, the authorization service 92 calculates a new data analysis usage by adding the data size notified at the step S169 to the data analysis usage corresponding to the contract ID included in the notification at the step S169. In addition, the authorization service 92 calculates a new available data analysis usage by subtracting the data size notified at the step S169 from the available data analysis usage corresponding to the contract ID included in the notification at the step S169.

After the process at the step S170, the authorization service 92 notifies the API platform 52 that updating the data analysis usage and the available data analysis usage is completed (S171).

Upon the API platform 52 receives the notification at the step S171, the API platform 52 notifies the user terminal of the analysis result notified by the big data analyzer 44 at the step S168 (S172).

Upon the user terminal receives the notification at the step S172, the user terminal displays the analysis result notified by the API platform 52 at the step S172 on the display unit of the user terminal (S173).

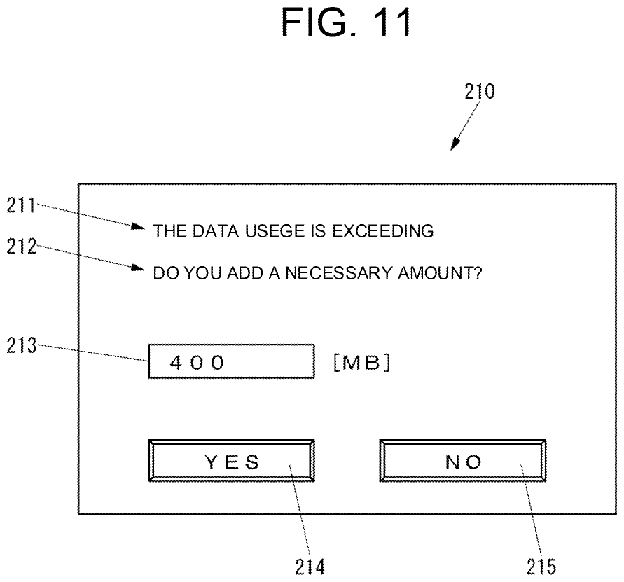

In the above described processes, when the data size of the analysis result exceeds the available data analysis usage, the user terminal displays a screen 200 (see FIG. 10), which inquiries the user about whether the user desires to modify the analysis contents to the new analysis contents, on the display unit of the user terminal at the step S167. However, when the data size of the analysis result exceeds the available data analysis usage, the user terminal may display a screen 210 (see FIG. 11), which inquiries the user about whether the user desires to increase the permitted data analysis usage, on the display unit of the user terminal at the step S167.

FIG. 11 is a diagram illustrating an example of the screen 210 displayed on the display unit of the user terminal at the step S167.

As shown in FIG. 11, the screen 210 includes a message 211 indicating that the data size of the analysis result exceeds the available data analysis usage, a message 212 for inquiring the user about whether the user desires to increase the permitted data analysis usage, a text box 213 for accepting a data amount to be increased in the permitted data analysis usage, a YES button 214 for accepting an instruction to increase the permitted data analysis usage, and a NO button 215 for accepting an instruction not to increase the permitted data analysis usage. The screen 210 displays the data which is notified to the user terminal by the API platform 52 at the step S166. The data amount to be increased shown in the text box 213 is the data amount that the big data analyzer 44 subtracts the available data analysis usage from the data size of the analysis result, and it may be the data amount that is notified to the API platform 52 by the big data analyzer 44 at the step S165. The data amount to be increased shown in the text box 213 can be changed through the operation unit of the user terminal.

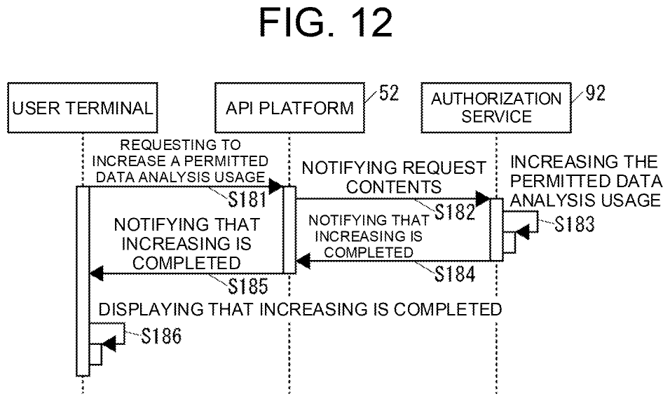

FIG. 12 is a sequence diagram illustrating the operation of the data coordination system 30 when increasing the permitted data analysis usage.

The user can press the YES button 214 when the user desires to increase the permitted data analysis usage, for example. Upon the YES button 214 is pressed, as shown in FIG. 12, the user terminal requests the API platform 52 to increase the permitted data analysis usage by the amount indicated in the text box 213 (S181).

Upon the API platform 52 receives request contents at the step S181, the API platform 52 notifies the authorization service 92 of the request contents at the step S181 (S182). The API platform 52 includes in the notification at the step S182 the contract ID included in the charging information contained in the authentication token included in the request at the step S141.

Upon the authorization service 92 receives the notification at the step S182, the authorization service 92 increases the permitted data analysis usage corresponding to the contract ID included in the notification at the step S182 in accordance with the request contents notified at the step S182 (S183).

After the process at the step S183, the authorization service 92 notifies the API platform 52 that increasing the permitted data analysis usage is completed (S184).

Upon the API platform 52 receives the notification at the step S184, the API platform 52 notifies the user terminal that increasing the permitted data analysis usage is completed (S185).

Upon the user terminal receives the notification at the step S185, the user terminal displays on the display unit of the user terminal that increasing the permitted data analysis usage is completed (S186). Therefore, the user can reinput the request for the data analysis into the operation unit of the user terminal. When the request for the data analysis is reinput into the user terminal, the API platform 52 can re-execute the process at the step S148. In the above described processes, although an example in which the request for the data analysis is reinput into the user terminal is described, even in a case where the processes are not configured so that the request for the data analysis is reinput into the user terminal, it is possible to re-execute the processes from the process at the step S148. For example, upon the API platform 52 receives the notification at the step S184, the API platform 52 may re-execute the process at the step S148. The user terminal may also accept a request to modify the analysis contents of the data to the new analysis contents when the process at the step S148 is re-executed.

When the authorization service 92 increases the permitted data analysis usage at the step S183, the authorization service 92 may reset the permitted data analysis usage to a default value for each user at the same timing as a timing of updating the data analysis usage, such as every month, for example.

As described above, since the data coordination system 30 does not notify the user of the analysis result when the data size of the analysis result of the data exceeds the available data analysis usage which is managed by the authorization service 92 for the user authenticated by the authentication service 91 (S166), it is possible to limit the use of the analysis service of the data for each user based on the data size of the analysis result. Therefore, the data coordination system 30 can prevent an amount of charge based on the data analysis usage from exceeding the user's assumption when the data size of the analysis result of the data exceeds the user's expectation. Namely, the data coordination system 30 can appropriately execute charging on the basis of the data analysis usage.

Since the data coordination system 30 can charge based on the data analysis usage, it can charge appropriately no matter what the analysis technology of the data used by the big data analyzer 44 is.

Since the data coordination system 30 does not notify the user of the analysis result and, as shown in FIG. 10, can accept an instruction to change the analysis contents of the big data analyzer 44 when the data size of the analysis result of the data exceeds the available data analysis usage which is managed by the authorization service 92 for the user authenticated by the authentication service 91, it is possible to continue the use of the analysis service of the data with the user's consent, and thus improve convenience in a case of limiting the use of the analysis service of the data for each user based on the data size of the analysis result.

Since the data coordination system 30 does not notify the user of the analysis result and, as shown in FIG. 11, can accept an instruction to increase the available data analysis usage when the data size of the analysis result of the data exceeds the available data analysis usage which is managed by the authorization service 92 for the user authenticated by the authentication service 91, it is possible to continue the use of the analysis service of the data with the user's consent, and thus improve convenience in a case of limiting the use of the analysis service of the data for each user based on the data size of the analysis result.

What is claimed is:

1. A data coordination system comprising:
a data collection system to collect data held by an information system;
a big data analyzer to analyze the data collected by the data collection system;
an API platform to provide an API (Application Program Interface) to execute a specific operation by using the data managed by the big data analyzer;
an authentication service to authenticate a user; and
an authorization service to manage for each user an available data analysis usage usable by the big data analyzer,
wherein when a data size of an analysis result by the big data analyzer does not exceed the available data analysis usage that is managed by the authorization service for the user authenticated by the authentication service, the API platform notifies the user of the analysis result, and
when the data size exceeds the available data analysis usage that is managed by the authorization service for the user authenticated by the authentication service, the API platform does not notify the user of the analysis result and can accept at least one of an instruction to change an analysis content of the big data analyzer and an instruction to increase the available data analysis usage.

2. An API platform to provide an API (Application Program Interface) to execute a specific operation by using data managed by a big data analyzer that analyzes data collected by a data collection system that collects data held by an information system,
wherein when a data size of an analysis result by the big data analyzer does not exceed an available data analysis usage that is managed by an authorization service that manages for each user the available data analysis usage usable by the big data analyzer for the user authenticated by an authentication service, the API platform notifies the user of the analysis result, and
when the data size exceeds the available data analysis usage that is managed by the authorization service for the user authenticated by the authentication service, the API platform does not notify the user of the analysis result and can accept at least one of an instruction to change an analysis content of the big data analyzer and an instruction to increase the available data analysis usage.
